(19) United States
(12) Patent Application Publication
(10) Pub. No.: US 2009/0183235 A1
(43) Pub. Date: Jul. 16, 2009

(54) FORM-FILE BASED INFORMATION SYSTEM AND ASSOCIATED METHODS

(76) Inventor: Vijayalakshmi Vellayan, Falls Church, VA (US)

Correspondence Address: DOUGLAS J. VISNIUS, 2519 ST. HEATHER WAY, ORLANDO, FL, 32806-5073, US

(21) Appl. No.: 11/858,023

(22) Filed: Sep. 19, 2007

Related U.S. Application Data
(60) Provisional application No. 60/846,040, filed on Sep. 20, 2006.

(51) Int. Cl. G06F 21/00

(52) U.S. Cl. 726/4

(57) ABSTRACT

An information system that may include a communications network, a server connected to the communications network, and a form-file on the server. The information system may also include a user-client to populate a first portion of the form-file based upon user information and to select user granted permissions for the user information. The information system may further include a contributor-client to populate a second portion of the form-file with contributor information based upon the user information and the user granted permissions, and a recipient-client to access the form-file with the user information and the contributor information as controlled by the user granted permissions.

### RELATED APPLICATION

This application is based upon prior filed copending provisional application Ser. No. 60/846,040 filed Sep. 20, 2006, the entire subject matter of which is incorporated herein by reference in its entirety.

### FIELD OF THE INVENTION

The invention relates to the field of information systems, and, more particularly, to information systems using form-files and related methods.

### BACKGROUND OF THE INVENTION

There are many information systems that may enable a form to be filled out or populated based upon information entered by a user. For example, the Kablesh et al. '754 published application may disclose a system for storing information that is used to automatically fill out a form based upon user information. Such information may include medical information about the user.

Another system is the O'Neil, et al. '440 patent, which may disclose a system for sharing user data based upon user granted permissions. In this system, the user granted permissions may be defined for each piece of user information entered into the system.

The Light, et al. '380 patent may disclose a system for automatically filling in forms on a web page based upon tags and information stored in a storage associated with a particular tag. The system may also include an authorization unit that controls access to the information stored in the storage.

The Elias, et al. '971 patent discloses a system to generate and deliver forms to a user. The system may include a user-file and an authentication function based upon the user-file.

The Blechman '847 published application discloses a personal health data system. The system may include enabling third parties access to particular health data based upon user granted permissions.

The Camp et al. '569 published application discloses a system to manage and track child welfare services. The system may include a user-file for a child stored in a database, and third parties may be granted access to particular data based upon granted permissions.

Unfortunately, the above systems may not effectively and efficiently provide an information service for all users' needs.

### SUMMARY OF THE INVENTION

In view of the foregoing background, it is therefore an object of the invention to provide a form-file based information system that may control the flow of user information.

This and other objects, features, and advantages in accordance with the invention are provided by an information system that may include a communications network, a server connected to the communications network, and a form-file on the server. The information system may also include a user-client to populate a first portion of the form-file based upon user information and to select user granted permissions for the user information. The information system may further include a contributor-client to populate a second portion of the form-file with contributor information based upon the user information and the user granted permissions. A recipient-client may access the form-file with the user information and the contributor information as controlled by the user granted permissions.

The contributor-client may certify the contributor information. The server may track the dates of creation for the user information and the contributor information to help control staleness of the user information and the contributor information. Further, the server may send out reminders to the user-client, the recipient-client, and the contributor-client based upon the dates of creation for the user information and the contributor information.

The user-client, the recipient-client, and the contributor-client may each add respective related information to the form-file. In addition, the user-client, the recipient-client and the contributor-client may each notify the others of the added related information.

The information system may further comprise at least one additional-client that receives portions of the form-file from the user-client, the recipient-client, and the contributor-client. The server may present the form-file in a first spoken language and the server may store the user information entered in a second spoken language. Also, the server may record accesses of the form-file, and the user-client, the recipient-client, and the contributor-client can view such recorded accesses.

The form-file may be subdivided into blocks of user information controlled by the user granted permissions. The blocks of user information in the form-file may be further controlled by recipient-client granted permissions and contributor-client granted permissions. Accordingly, an information system may be provided that that may control the flow of user information.

Another aspect of the invention is a method for using an information system. The method may include providing a form-file, and populating with a user-client a first portion of the form-file based upon user information and selecting user granted permissions for the user information. The method may further include populating with a contributor-client a second portion of the form-file with contributor information based upon the user information and the user granted permissions, and accessing through a recipient-client the form-file with the user information and the contributor information as controlled by the user granted permissions.

### BRIEF DESCRIPTION OF THE DRAWINGS

FIG. 1 is a schematic block diagram of an information system in accordance with the invention.

FIG. 2 is a flowchart illustrating method aspects according to the invention.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one skilled in the art, the invention may be embodied as a method, system, or computer program product. Furthermore, the invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the invention may be written in an object oriented programming language such as Java, Smalltalk, C++ or the like. However, the computer program code for carrying out operations of the invention may also be written in conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

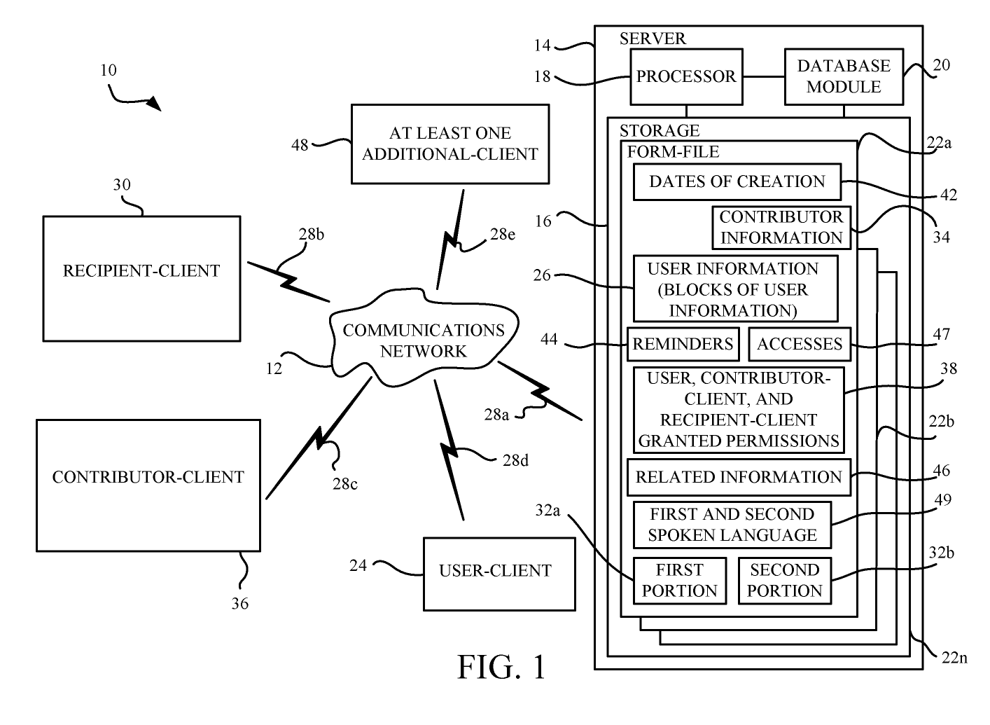

Referring initially to FIG. 1, an information system 10 to control the flow of information about a user is initially described. The information system 10 includes a server 14 connected to a communications network 12 via communication link 28a, which may be a wired link, a wireless link, or a combination of a wired link and wireless link as will be appreciated by those of skill in the art.

The information system 10 also includes storage 16 in communication with the server 14, for example. The server 14 includes a processor 18 or other logic circuitry for signal processing, which is connected to the storage 16 as will be appreciated by those of skill in the art. In other embodiments, the storage 16 may be embedded in the processor 18. In one embodiment, the server 14 includes a database module 20 to aid processor 18 with accessing and storing information in storage 16 as will be appreciated by those of skill in the art.

The system 10 also includes a form-file 22a on the server 14, for example. A file provides a block of data to a signal processing unit such as server 14. The form-file 22a includes at least a first portion 32a and a second portion 32b.

In other embodiments, the system 10 includes a plurality of additional form-files 22b-22n in the storage 16. Form-files 22a-22n contain user information 26 and user granted permissions 38.

User information 26 includes data about, and describing, a user, e.g. name, address, birth date, medical information, educational history, work history, or the like, as will be appreciated by those of skill in the art. User granted permissions 38 are access rights to the user information 26 selected and/or defined by the user. In other words, the user has the ability to control other parties' access to the user information 26 base upon user defined rules of access embodied in the user granted permissions 38. Form-files 22b-22n each contains user information 26 and user granted permissions 38 for different users.

The system 10 further includes a user-client 24 connected to the server 14 via the communications network 12 through communication link 28d as will be appreciated by those of skill in the art. User-client 24 has some processing capacity and interacts with the server 14 through a website, in a client/server fashion, or the like. A client, such as user-client 24, may be a cell phone, a personal digital assistant, a laptop computer, a personal computer, a workstation, a signal processing kiosk, or the like. The user-client 24 enables a user to add/change/delete at least one of user information 26 and user granted permissions 38 in a user-file 22a-22n for which a given user has access rights to. For example, the user-client 24 enables a user to populate a first portion 32a of the form-file 22a to provide user information 26 and to select and/or define user granted permissions 38 for the user information.

The information system 10 further includes a contributor-client 36 connected to server 14 via the communications network 12 through communication link 28c as will be appreciated by those of skill in the art. The contributor-client 36 has some processing capacity and interacts with server 14 through a website, in a client/server fashion, or the like. The contributor-client 36 provides contributor information 34, which is information about the user generated by a party using the contributor-client 36. Examples of contributor information 34 are medical records about the user, driving records about the user, insurance records related to the user, or the like.

In one embodiment, the contributor-client 36 is used to populate the second portion 32b of the form-file 22a with contributor information 34 based upon the user information 26 and user granted permissions 38. In other words, the user controls what contributor information 34 is entered into the second portion 32b through the user granted permissions 38. In one embodiment, the contributor-client 36 certifies the contributor information 34 using an electronic signature or the like as will be appreciated by those of skill in the art.

The system 10 further includes a recipient-client 30 connected to server 14 via the communications network 12 through communication link 28b as will be appreciated by those of skill in the art. The recipient-client 30 has some processing capacity and interacts with server 14 through a website, in a client/server fashion, or the like. The recipient-client 30 access of the form-file 22a with the user information 26 and the contributor information 34 is controlled by the user granted permissions 38, for example.

In one embodiment, the server 14 tracks the dates of creation 42 of the user information 26 and/or the contributor information 34 to help control staleness of the user information and the contributor information. Further, the server 14 sends out reminders 44 to the user-client 24, the recipient-client 30, and/or the contributor-client 36 based upon the dates of creation 42 for the user information 26 and the contributor information 34. For example, if contributor information 34 is certified and the certification is only valid for one year, then a reminder 44 may be sent to the user-client 24, the recipient-client 30, and/or the contributor-client 36 to notify the impacted parties of such.

In another embodiment, the user-client 24, the recipient-client 30, and the contributor-client 36 may each add respective related information 46 to the form-file 22a. The related information 46 is data based upon the user information 26 and data generated during interaction of the user of the user-client 24 and the users of the recipient-client 30 and the contributor-client 36. In addition, the user-client 24, the recipient-client 30, and the contributor-client 36 may each notify the others of the any related information 46 added to the form-file 22a.

The information system 10 further includes at least one additional-client 48 connected to the server 14 via the communications network 12 through communication link 28e as will be appreciated by those of skill in the art. The at least one additional-client 48 has some processing capacity and interacts with server 14 through a website, in a client/server fashion, or the like. The at least one additional-client 48 receives portions of the form-file 22a from the user-client 24, the recipient-client 30, and the contributor-client 36.

In one embodiment, the server 14 presents the form-file 22a in a first spoken language 49, e.g. Spanish, and the server stores the user information 26 entered in a second spoken language, e.g. English. For instance, a user viewing the first portion 32a of the form-file 22a on the user-client 24 may see such in a first spoken language 49 while a user of the recipient-client 30 may access the user information as stored in a second spoken language, and vice versa.

In one embodiment, the server 14 records accesses 47 of the form-file 22a, and the user-client 24, the recipient-client 30, and/or the contributor-client 36 can view such recorded accesses. For example, a user through user-client 24 can monitor who has viewed user information 26, contributor information 34, and/or related information 46 by reviewing the accesses 47. In addition, the recipient-client 30 and/or the contributor-client 36 can see who has viewed user information 26, contributor information 34, and/or related information 46 within the limits of the user granted permissions 38, for instance.

In one embodiment, the form-file 22a is subdivided into blocks of user information 26 controlled by the user granted permissions 38. In other words, a user via user-client 24 can grant access rights to specified blocks of user information 26, contributor information 34 and/or related information 46. Additionally, the blocks of user information 26 in the form-file 22a may be further controlled by recipient-client granted permissions and contributor-client granted permissions 38. In one embodiment the recipient-client granted permissions and contributor-client granted permissions 38 are based upon the user granted permissions 38. Accordingly, an information system 10 is provided that helps a user via user-client 24 to control the flow of information in the form-file 22a.

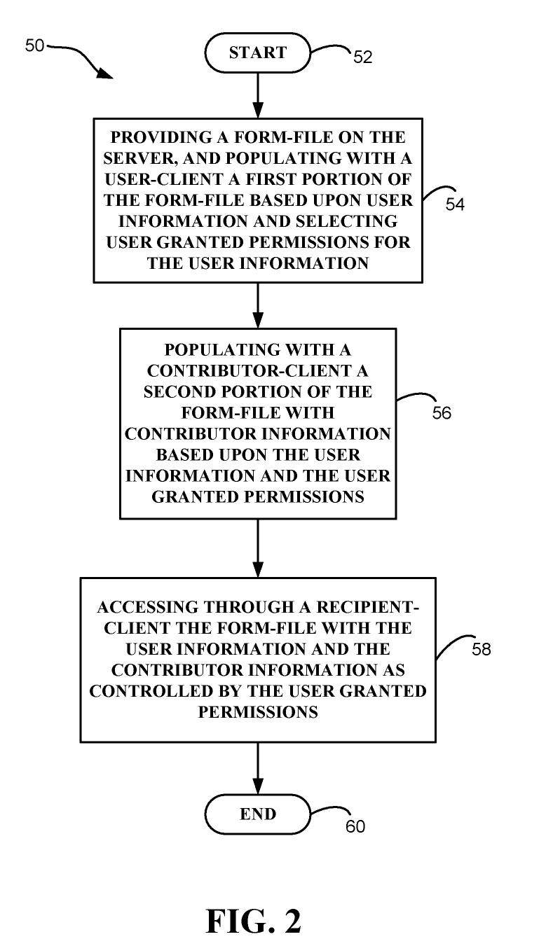

Another aspect of the invention is a method for using the information system 10, which is now described with reference to flowchart 50 of FIG. 2. The method begins at Block 52 and may include providing a form-file 22a, and populating with a user-client 24 a first portion 32a of the form-file based upon user information 26 and selecting user granted permissions 38 for the user information at Block 54. The method may also include populating with a contributor-client 36 a second portion 32b of the form-file 22a with contributor information 34 based upon the user information 26 and the user granted permissions 38 at Block 56. The method may further include accessing through a recipient-client 30 the form-file 22a with the user information 26 and the contributor information 34 as controlled by the user granted permissions 38 at Block 58. The method may end at Block 50.

A prophetic example of how the system 10 may work is now described. A student entering a school usually has to provide health information to the school. The health information may include immunization records, a record of medical conditions, a record of medications the student takes, a list of medical authorizations, or the like. In addition, such information may become stale or require resubmission within a certain time period. The system 10 enables a parent or guardian to provide the school such information while being able to monitor the information and to control who has access to such information.

For example, a user, e.g. parent or guardian, would use their home computer, a school kiosk, or the like, e.g. user-client 24, to add health information, e.g. user information 26, to a form-file 22a on the server 14 about their child. The form-file 22a would also permit the user to limit access to the user information 26 by permitting the selection or defining of user granted permissions 38. The form-file 22a is placed on the server 14 by the school, e.g. recipient-client 30, for example.

Further, the user (user-client 24) may not have the ability or right to supply certain health information (user information 26). For example, immunization records may have to be certified before the school (recipient-client 30) will accept them. As a result, the system 10 enables a doctor's office (contributor-client 36) to provide such as contributor information 34 in a second portion 32b of the form-file 22a based upon user granted permissions 38. In other words, the user (user-client 24) still controls what information the school (recipient-client 30) receives from the doctor (contributor-client 36). In addition, the system 10 enables the contributor information 34 to be certified by an authenticated electronic signature or the like.

Providing multiple portions to the form-file 22a is advantageous to the school (recipient-client 30) because it prevents numerous form-file related problems, e.g. formatting issues, updating issues, collating issues, filing issues, or the like. In many cases, the school (recipient-client 30) would also like to add information the form-file 22a such as information about events relating to the student during the school year, e.g. related information 46.

For instance, if the student faints at school, the school can note this in the related information 46. Since, the user (user-client 24) has access to the form-file 22a, the user can monitor what has happened at school. In another embodiment, the school can push the information in real-time to the user. For example, the user could be notified on a user-client 24 such as a cell phone, personal digital assistant, computer, or the like.

In one embodiment, the school can grant access to blocks of user information 26 based upon a tiered system. For instance, a math teacher may be granted access to a first block of user information, e.g. level 1, which discloses basic identifying data about the student while a school nurse may be granted access to a second block of user information that discloses the same basic identifying data and information about any medical conditions the student may have, e.g. level 2. Further, a school administrator may be granted access to a third block of user information, e.g. level 3, which discloses the basic identifying data, the medical conditions information, and information associated with any related information 46 that was entered by the school.

The system 10 further includes at least one additional-client 48 to receive portions of the form-file 22a from at least one of the user-client 24, the recipient-client 30, and the contributor-client 36. For example, the school may have to submit portions of the student health information generated in the form-file 22a to a state regulatory body in order to fulfill compliance requirements.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. An information system comprising:
a communications network;
a server connected to said communications network;
a form-file on said server;
a user-client to populate a first portion of said form-file based upon user information and to select user granted permissions for the user information;
a contributor-client to populate a second portion of the form-file with contributor information based upon the user information and the user granted permissions; and
a recipient-client to access said form-file with the user information and the contributor information as controlled by the user granted permissions.

2. The information system of claim 1 wherein said contributor-client certifies the contributor information.

3. The information system of claim 1 wherein said user-client, said recipient-client, and said contributor-client can each add respective related information to the form-file.

4. The information system of claim 3 wherein said user-client, said recipient-client and said contributor-client each notifies at least one of the others of added related information.

5. The information system of claim 1 further comprising at least one additional-client that receives portions of said form-file from at least one of said user-client, said recipient-client, and said contributor-client.

6. The information system of claim 1 wherein said server presents said form-file in a first spoken language and said server stores the user information entered in a second spoken language.

7. The information system of claim 1 wherein said form-file is subdivided into blocks of user information controlled by the user granted permissions.

8. The information system of claim 7 wherein the blocks of user information in said form-file is further controlled by at least one of recipient-client granted permissions and contributor-client granted permissions.

9. The information system of claim 1 wherein said server records access to said form-file; and wherein at least one of said user-client, said recipient-client, and said contributor-client can view such access.

10. The information system of claim 2 wherein said server tracks dates of creation for the user information and the certified contributor information to, at least one of, help control staleness of the user information and the certified contributor information, and send out reminders to said user-client, said recipient-client, and said contributor-client based upon the dates of creation for the user information and the certified contributor information.

11. A method for using an information system, the method comprising:
providing a form-file;
populating with a user-client a first portion of the form-file based upon user information and selecting user granted permissions for the user information;
populating with a contributor-client a second portion of the form-file with contributor information based upon the user information and the user granted permissions; and
accessing through a recipient-client the form-file with the user information and the contributor information as controlled by the user granted permissions.

12. The method of claim 11 further comprising certifying the contributor information.

13. The method of claim 11 further comprising adding related information to the form-file through at least one of the user-client, the recipient-client, and the contributor-client.

14. The method of claim 11 further comprising subdividing the form-file into blocks of user information controlled by the user granted permissions.

15. The method of claim 14 further comprising controlling the blocks of user information in the form-file further by at least one of recipient-client granted permissions and contributor-client granted permissions.

16. The method of claim 11 further comprising recording access to the form-file and where at least one of the user-client, the recipient-client, and the contributor-client can view such access.

17. A computer program product embodied in a tangible media comprising:
computer readable program codes coupled to the tangible media for using an information system, the computer readable program codes configured to cause the program to:
provide a form-file;
populate with a user-client a first portion of the form-file based upon user information and to select user granted permissions for the user information;
populate with a contributor-client a second portion of the form-file with contributor information based upon the user information and the user granted permissions; and
access through a recipient-client the form-file with the user information and the contributor information as controlled by the user granted permissions.

18. The computer program product of claim 17 further comprising program code configured to: certify the contributor information.

19. The computer program product of claim 17 further comprising program code configured to: add related information to the form-file through at least one of the user-client, the recipient-client, and the contributor client.

20. The computer program product of claim 17 further comprising program code configured to: subdivide the form-file into blocks of user information controlled by the user granted permissions.
